(19) United States
(12) Patent Application Publication
(10) Pub. No.: US 2024/0005338 A1
(43) Pub. Date: Jan. 4, 2024

(54) UNIFIED WATER-RELATED OPERATING SYSTEM AND METHOD

(71) Applicant: Klir Platform Europe Limited, Dublin 2 (IE)

(72) Inventors: David LYNCH, Toronto (CA); Elaine KELLY, Toronto (CA)

(21) Appl. No.: 17/857,099

(22) Filed: Jul. 4, 2022

(51) Int. Cl. G06Q 30/00; G06Q 50/26

(52) U.S. Cl. CPC G06Q 30/018; G06Q 50/26

(57) ABSTRACT

The systems and methods described herein provide, in accordance with different embodiments, different examples of unified systems and methods that allow to automate or streamline, at least partially, a plurality of tasks related to one or more water-related services or functions provided by or under the authority of a water-related entity.

### FIELD OF INVENTION

The present disclosure relates to water management, and, in particular, to a unified water-related operating system and method.

### BACKGROUND

Water utilities generate massive amounts of data, but only use a faction of it. In addition, the data often comes from disparate sources, in various formats, and generated on different schedules. Organizing, processing, and interpreting that data can be time-consuming or can lead to inefficiencies.

In addition, increasing regulations, ageing infrastructure and fragmented expenditure allocation can add pressure on the utilities to become more efficient and sustainable. There is a lack of a single integrated system to manage water which emulates the watershed or catchment based approach to water management. Thus, there is a need for a more unified system and method that provides cross-functionality across all these different water-related business elements.

This background information is provided to reveal information believed by the applicant to be of possible relevance. No admission is necessarily intended, nor should be construed, that nay of the preceding information constitutes prior art or forms part of the general common knowledge in the relevant art.

### BRIEF SUMMARY

The following presents a simplified summary of the general inventive concept(s) described herein to provide a basic understanding of some aspects of the disclosure. This summary is not an extensive overview of the disclosure. It is not intended to restrict key or critical elements of the embodiments of the disclosure or to delineate their scope beyond that which is explicitly or implicitly described by the following description and claims.

A need exists for a unified system and method that allows to automate or streamline, at least partially, a plurality of tasks related to one or more water-related services or functions provided by or under the authority of a water-related entity. This may include, in some embodiments, evaluating and managing a plurality of requirements, legal or otherwise. Some aspects of disclosure provide embodiments of such systems and methods.

In accordance with a first aspect, there is provided a computer-implemented method for automatically evaluating compliance requirements of a water-related entity, the water-related entity providing one or more water-related services, the method comprising: receiving, on a server, from a plurality of network-connected devices communicatively coupled to the server via a network, a plurality of data elements, each data element being associated with one of said plurality of water-related services; receiving, on the server, from said plurality of network-connected devices, a plurality of Boolean inputs, each input describing a logic-based rule that is to be automatically evaluated against at least a subset of the plurality of data elements; for each input of the plurality of Boolean inputs: processing, on the server, each logic-based rule on said subset to identify a triggering event; and displaying, on at least some of said plurality of network-connected devices, said triggering event.

In one embodiment, the method further comprises the steps of: creating, from the plurality of network-connected devices, a plurality of water-related tasks, each of said plurality of water-related tasks being associated with one of said plurality of water-related services; storing said plurality of water-related tasks on a database communicatively coupled to said server; displaying to the user, on at least one device of said plurality of network-connected devices, a list of the plurality of water-related tasks.

In one embodiment, at least some of said plurality of tasks are created via a task generator using a task template.

In one embodiment, each of said task further has attached thereto one of: comments, forms, questions, and attached files.

In one embodiment, each of said task has a tag attached to it, the tag being associated with another user, and wherein upon said task being created, automatically sending an electronic message to said another user.

In one embodiment, said using a task template comprises the steps of: selecting a task type template from a list of task templates; associating the task with one or more of said plurality of data elements; inputting an end date, due date and recurrence; and adding one of: a form, a question, or a tag.

In one embodiment, said task type templates includes: a general task, a sample tasks linked to a monitoring plan, a permit task linked to a specific permit, an emission task linked to a specific permit.

In one embodiment, at least one of said plurality of data elements is a permit data element that comprises permit information and wherein said task is associated with said permit data element is directed to a compliance requirement of said permit.

In one embodiment, at least one of said plurality of data elements is associated with an asset of said water-related entity.

In one embodiment, said asset is a generator and at least one of said data elements is an asset data element comprising a number of hours the generator has been running.

In one embodiment, an amount of contaminant is automatically derived from said number of hours the generator has been running.

In accordance with another aspect, there is provided a system for automatically evaluating compliance requirements of a water-related entity, the water-related entity providing one or more water-related services, the system comprising: one or more servers; one or more databases communicatively coupled to said one or more servers and used to store thereon a plurality of data elements, each data element being associated with one of said plurality of water-related services; a plurality of network-connected devices communicatively coupled to said one or more servers via a network; and wherein the one or more servers are configured to: receive, from the plurality of network-connected devices, a plurality of data elements, each data element being associated with one of said plurality of water-related services; receive, from said plurality of network-connected devices, a plurality of Boolean inputs, each input describing a logic-based rule that is to be automatically evaluated against at least a subset of the plurality of data; and for each Boolean input: processing said logic-based rule on said subset to identify a triggering event; and displaying, on at least some of the plurality of network-connected devices, said triggering event.

In one embodiment, the system is further configured to: create, on the plurality of network-connected devices, a plurality of water-related tasks, each of said plurality of water-related tasks being associated with one of said plurality of water-related services; store said plurality of water-related tasks on said one or more databases; displaying on the user device, a list of the plurality of water-related tasks.

In one embodiment, at least some of said plurality of tasks are created via a task generator using a task template.

In one embodiment, each of said task further has attached thereto one of: comments, forms, questions, and attached files.

In one embodiment, each of said task has a tag attached to it, the tag being associated with another user, and wherein upon said task being created, sending an electronic message to said another user.

In one embodiment, said using a task template comprises the steps of: selecting a task type template from a list of task templates; associating the task with one or more of said plurality of data elements; inputting an end date, due date and recurrence; and adding one of: a form, a question, or a tag.

In one embodiment, at least one of said plurality of data elements is associated with an asset of said water-related entity.

In one embodiment, said asset is a generator and the at least one of said plurality of data elements associated with said asset includes a number of hours the generator has been running.

In one embodiment, an amount of contaminant is automatically derived from said number of hours the generator has been running.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1 illustrates schematically a unified water-related operating system, in accordance with one embodiment;

FIG. 2 illustrates schematically another implementation of the system of FIG. 1, in accordance with one embodiment;

FIG. 3A illustrates schematically a list of application services provided by the system of FIG. 1, in accordance with one embodiment;

FIG. 3B illustrates schematically a list of application components of the system of FIG. 1, in accordance with one embodiment;

FIG. 4 illustrates a login screen to the platform implemented by the system of FIG. 1, in accordance with one embodiment;

FIG. 5 illustrates a dashboard view, in accordance with one embodiment;

FIGS. 6, 7 and 8 illustrate different views of a task manager, in accordance with one embodiment;

FIGS. 9, 10, 11, 12 and 13 illustrate different view related to the task manager, in accordance with one embodiment;

FIG. 14 illustrates a calendar view of the task manager, in accordance with one embodiment;

FIGS. 15, 16, 17, 18, and 19 illustrate different views of a permit-related features, in accordance with one embodiment;

FIGS. 20, 21, 22, 23, 24, 25, and 26 illustrate different views of a sampling and monitoring plan related features, in accordance with one embodiment;

FIGS. 27, 28, 29, 30, 31, 32 and 33 illustrate different views of a compliance-related features and rules engine, in accordance with one embodiment;

FIGS. 34, 35, 36, 37 and 38 illustrate different views of a treatment plants manager, in accordance with one embodiment;

FIGS. 39 to 42 illustrate different views of a community-related features, in accordance with one embodiment;

FIGS. 43 and 44 illustrates different views of a data management feature, in accordance with one embodiment;

FIGS. 45 to 47 illustrate different views of report generator and manager, in accordance with one embodiment; and

FIG. 48 is a schematic diagram illustrating an exemplary computing device, in accordance with one embodiment.

Elements in the several figures are illustrated for simplicity and clarity and have not necessarily been drawn to scale. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

The systems and methods described herein provide, in accordance with different embodiments, different examples of a unified platform for automating or streamlining a plurality of tasks or actions associated with one or more water-related services or functions of a water-related entity or authority. This may include, without limitation, automating, at least in part, repetitive day-to-day tasks associated with managing and maintaining the one or more water-related services, providing improved interactions or communications with stakeholders that are impacted by or have an impact on the water-related services (e.g., legal authorities, 3rd party entities, members of the general public) or managing a plurality of compliance requirements.

By water-related entity or authority, what is meant is any public or private organization or company which services include managing, transporting, treating, regulating, testing and/or using and/or disposing of a substantial amount of water (including potable water but also wastewater or stormwater). In some embodiments, this may include using water for the production of one or more products (whether the products themselves contain water or not), or using water as part of a manufacturing, agricultural or industrial process.

These systems and methods protect and enhance the health of water by in part simplifying compliance with regulations, in addition to reduces the risk of missed tasks and deadlines, but also fines and violations. In addition, they allow to gather all of a water utility's environmental data, for example by taking signals arising in a catchment or water-shed, in advance or as a result of regulatory enforcement action.

While the examples given below will be in the context of water utilities, the skilled person in the art will appreciate that other types of water-related entities or authorities may also use the systems and methods described in the present disclosure, without exception. Examples may include, but are not limited to: breweries, drink manufacturers, oil and gas industries, agriculture, processed food manufacturers, or the like. In some embodiments, a water-related entity may have authority on a plurality of 3rd-party or other water-related entities and be operable to enforce standards or regulatory obligations thereon.

Thus, by water-related services, it is to be understood any services or process that uses significant amounts of water. In some embodiments, this may include services related to water-consumption, for example in the case of water utilities or the like. For example providing, testing and distributing clean water to a plurality of individuals, while transporting, treating and disposing of the soiled water thereafter. It can also include “services” where water is to be provided and used via one or more industrial, resource extraction, agricultural or manufacturing process.

In some embodiments, the compliance requirements may be understood as legal requirements set by governmental entities (Countries, States, Cities, etc.) but also includes any requirement or goal, set by the water-related entity itself or any individuals related thereto. In the case of governmental entities, the compliance requirements may include environmental compliance requirements, for example limits on the amount of a given contaminant. However, the compliance requirements are to be understood broadly and include requirements related to the overall performance of one or more water-related services or functions provided by the water-related entity or necessary to its normal functioning.

In some embodiments, the expression “assets” in the present disclosure is meant to include any machine, system, apparatus, device, substance, material, or object under the direct or indirect control of and/or used by the water-related entity to provide said water-related services. For example, in the case of a water-utility, this may include generators, pumps, or any other device, system or object. In some embodiments, the assets may not necessarily be under the direct control of the water-entity but may be owned or operated by a 3rd party (e.g., another business or individual) and enforced/regulated/dedicated by the entity. As a non-limiting example, the water-related entity or authority could be a water-utility, and the asset an UV filter for wastewater in a brewery. Thus, the water-utility in this case does not own or operate the filter, but it may be authorized to dictate that the brewery has it in place and operates it to a standard set by the entity, and it may instigate enforcement actions if compliance is not respected. These assets may have working environmental or inspection requirements or obligations associated therewith.

In some embodiments, the systems and methods disclosed below may further be configured to be accessible by 3rd parties or members of the general public, so that they may interact with relevant water-related entities or authorities so that they may take actions. For example, this may include, without limitation, a web portal or the like for members of the public to log on, so that they may apply, pay or manage access to a plurality of water-related services provided by the entity/authority.

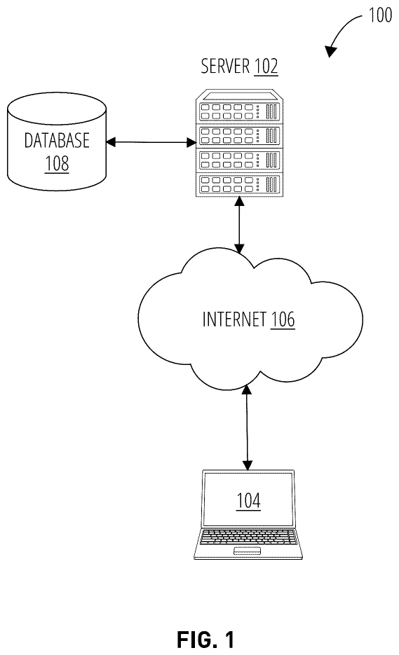

Referring now to FIG. 1, a system 100 implementing the unified water-related management platform will now be described. In this particular embodiment, as an example only, the system 100 is implemented as a cloud-based software-as-a-server (SaaS) platform or the like. This allows any individual, user or stakeholder related to the water-related entity (e.g., employee, manager, administrator, supervising authority, member of the general public, etc.) to advantageously connect one or more servers 102 via the use of any internet-connected user device 104 over a data communication network, for example the internet 106.

In some embodiments, the user device 104 may include any network-connected computing device known in the art, for example but not limited to: desktop computers, laptops, smartphones, smartwatches, tablets, or the like. In some embodiments, a client application or software may be installed on the user device 104 to allow the device to be communicatively coupled to the servers 102. In other embodiments, the user may access the system via a web front end using a web browser or the like.

In some embodiments, the servers 102 may comprise or be communicatively coupled to one or more databases 108 to receive and store data thereon. These may include, for example, a relational database management system, such as Azure SQL databases or the like, although the skilled person in the art will appreciate that any Cloud-based infrastructure known in the art may be used, without limitation. In addition, user device 104 and servers 102 may be communicatively coupled via any known cryptographic process known in the art.

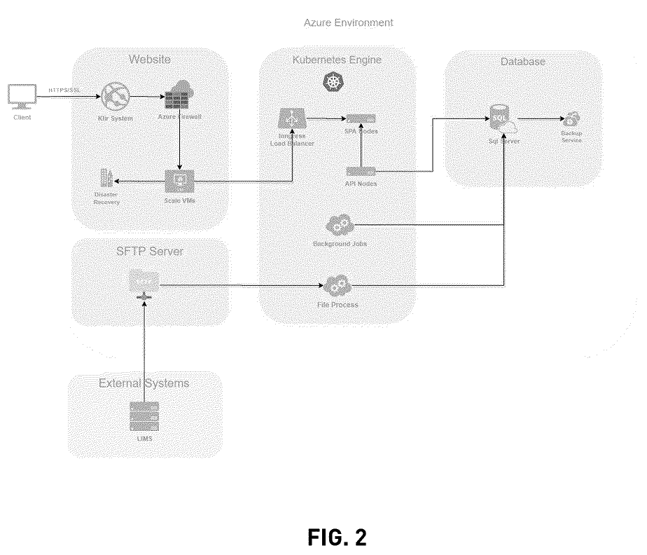

FIG. 2 illustrates schematically a more detailed implementation, as an example only, of the embodiment of system 100 using the Azure environment.

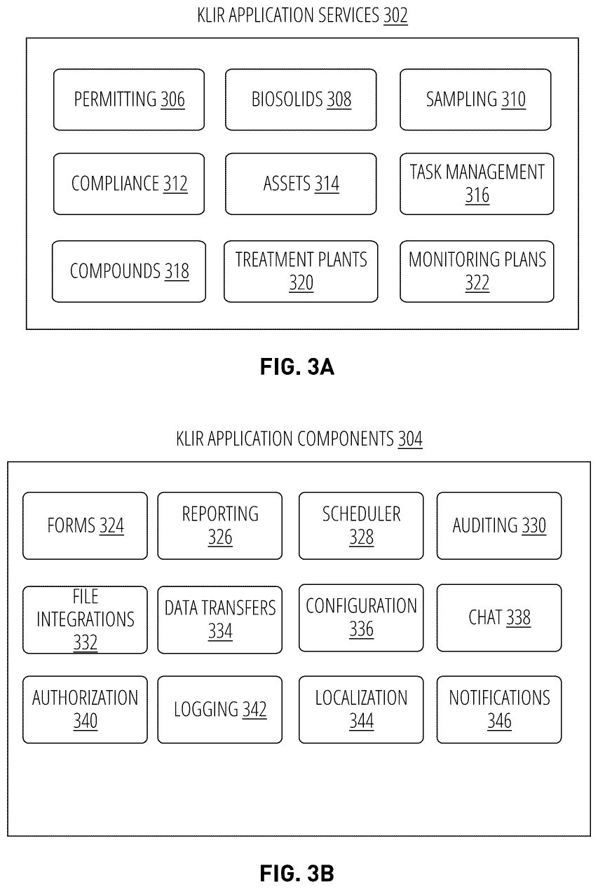

FIGS. 3A and 3B shows schematically different application services 302 and components 304 offered by the platform (e.g., the Klir Platform) implemented via system 100, in accordance with one embodiment. The Klir Application services 302 may include, for example, permitting 306, biosolids 308, sampling 310, compliance 312, asset management 314, task management 316, compound management 318, treatment plants management 320 and monitoring plans management 322.

FIG. 3B illustrates an exemplary list of application components/features 304. These may include, as an example only, forms 324, reporting 326, scheduler 328, auditing 330, file integrations 332, data transfers 334, configuration 336, chat or instant communications between users 338, authorization 340, logging 342, localization 344 and/or notifications 346.

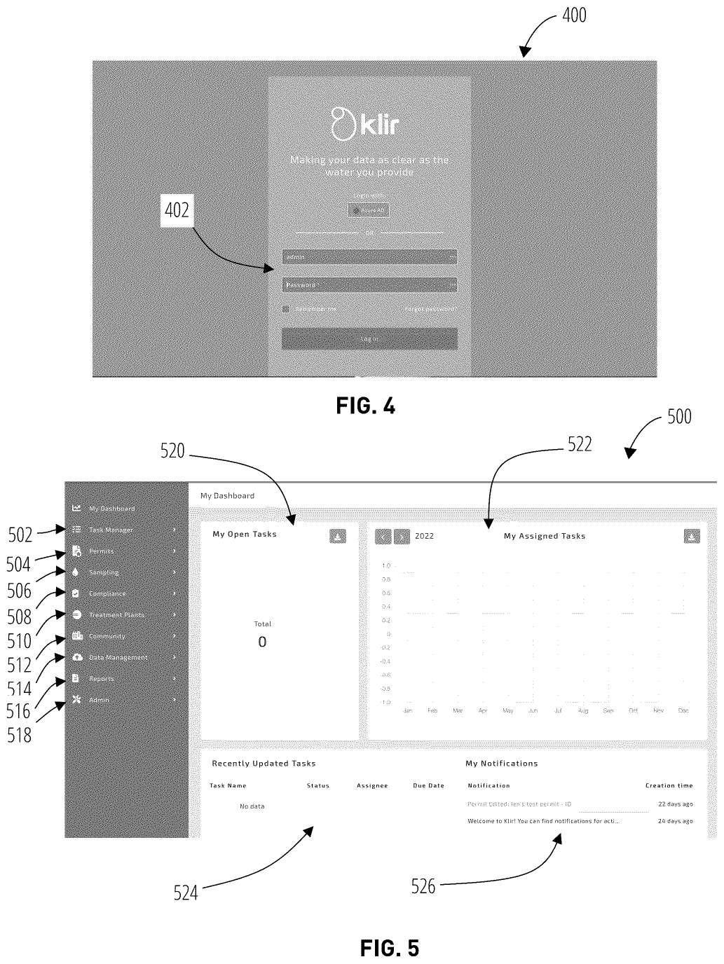

With reference to FIGS. 4 to 36, and in accordance with one exemplary embodiment, the user interface (UI) of the Klir Application services 302 as accessed by a user via the user device 104 and the different views and functionalities associated therewith will now be discussed. FIG. 4 shows an example of a login page, screen or view 400 used to access the Klir Application services 302. In some embodiments, this screen may ask the user to enter credentials 402 (e.g., a username and password) to access the Klir Application services 302. In some embodiments, other authentication methods or processes known in the art may also be used, for example third-party authentication services or methods.

In some embodiments, upon the user login in the system, the user is immediately presented with a dashboard view 500, an example of which is shown in FIG. 5. The dashboard view 500 is configured so as to give easy access to different features of the Klir Application services 302 and to show the most relevant information to the user. In some embodiments, the dashboard view 500 may be customizable by the user and the example discussed below represents only one of such examples.

In the example of FIG. 5, multiple water-related services or functions or configuration options are illustrated in a lateral tab for easy access. In this example, the different options include: task manager 502, permits 504, sampling 506, compliance 508, treatment plants 510, community 512, data management 514, reports 516 and administrative settings 518. From these, a user can access the views associated with these options/elements. As will be discussed below, some tabs further have sub-tabs associated with them. The skilled person in the art will appreciate that functionalities associated with a given tab or sub-tab in the current example may be moved to a different tab or named differently, or be accessed via another type of window, button or other, without departing from the current disclosure.

In addition, in some embodiments, the dashboard view 500 may be configured to show different plots or diagrams, related, for example, to a the currently opened tasks 520, and/or an area 522 for displaying time-based plots (e.g., a weekly/monthly/yearly view or similar) showing a breakdown of the different tasks currently assigned to the user, including which tasks are currently opened or closed.

Further down the dashboard view 500, the listing of recently updated listing of recently updated tasks 524 is shown, which may be sorted, for example, by status, assignee, and due date, and a listing of notifications 526. These notifications may, for example, be sent to the user upon the user being tagged by another user or the system upon a new task being created, or by having another user mentioning the user in a comment. Additional examples of events that may trigger a notification includes, without limitation: a task being assigned to a user, a task being edited, a task being closed, a task form being submitted, a comment mentioning/tagging another user, an inspection being assigned, a data transfer requiring attention, a permit being edited, a new user registration (for Admins).

Generally, a task is any action that needs to be taken by an individual or sub-entity related to the water-related entity so as to ensure the normal activities or services provided by the water-related entity. In some embodiments, these tasks can also be used to create regulatory forms or questionnaires that can be submitted to a water-related regulating entity. In addition, tasks may be directed to any service or activity of the water-related entity, without restriction, and a plurality of individuals and/or other entities.

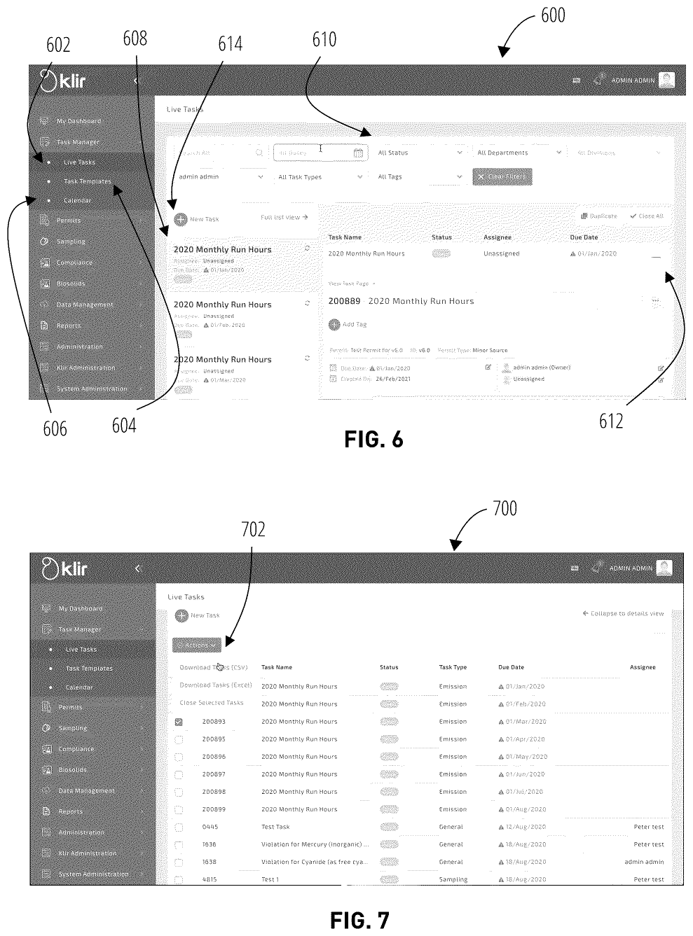

In some embodiments, the task manager tab 502 includes three sub-tabs: live tasks 602, task templates 604 and calendar 606. FIG. 6 shows an example of the live task view 600. This is used to view a listing of tasks 608 currently part of the database. This listing can be changed by the user using a plurality of search filters 610. Examples of task search filters include, without limitation, dates, status, departments/divisions, users, task types and/or tags. Upon a task being selected by the user, task details 612 related to the selected task are shown next to the listing 608. The task details may include, for example, the owner or assignee of the task, its status and its due date. The live task view 600 also allows a user to create a new task via a task creation button 614.

FIG. 7 shows the full list view 700 of the live task view 600, further comprising an action button 702 configured to allow the user to, for example, download the task listing (in CSV, Excel formats or other) or to close selected tasks.

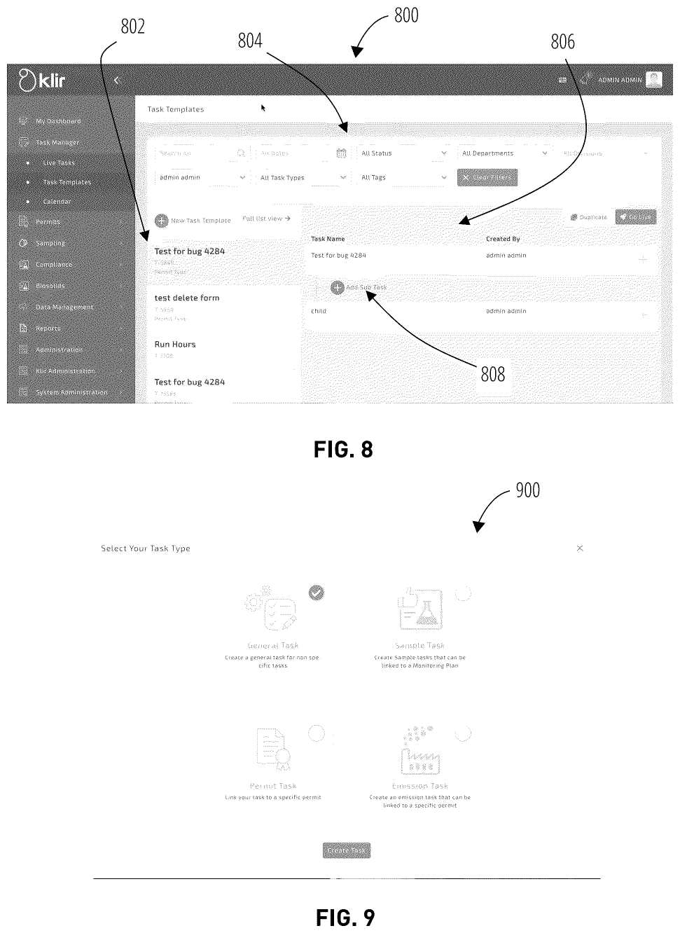

FIG. 8 shows an example of the task template view 800, which includes a listing of task templates 802, which can be filtered using a plurality of template filters 804. New tasks may be created from the selected templates, the details 806 of which are shown besides the listing 802. These may include, for example, a name and the user which created it. The tasks may be assigned to any user, and may include tags and/or comments. In some embodiments, sub-tasks or child tasks may be created or added to the task using a sub-task button 808.

FIGS. 9 to 13 show an example of views related to different steps presented to the user to help them create task templates. FIG. 9 shows a task template selection view 900 providing the user a chose between creating different types of tasks. There, the user may select to create a general task, or a permit task (linked to a specific permit), sample task (linked to a monitoring plan) or emission task (linked to a specific permit).

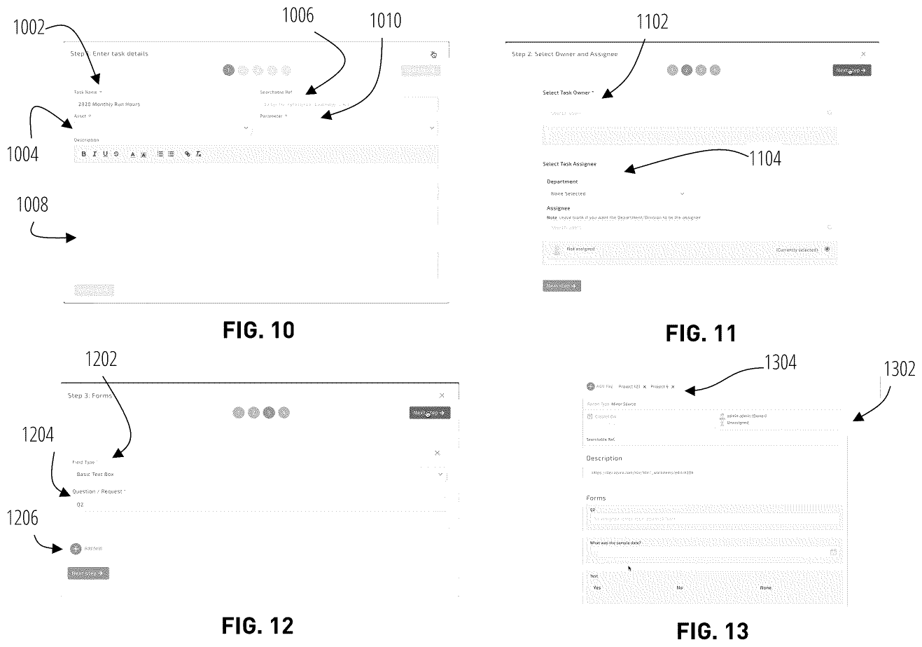

FIG. 10 shows step 1, wherein tasks details are entered by the user. These details may include, without restriction, the task name 1002, an asset 1004 linked to the task, a searchable reference 1006, a description item 1008 and a task-related parameter 1010. Once all the fields are entered, the user may continue to step 2.

FIG. 11 shows step 2 of the task creation process. There, the user fills out the task owner field 1102 and the task assignee field 1104, before moving to step 3. The task assignee field further is shown comprising a department selection list.

FIG. 12 shows step 3 of the task creation process. There, the user may add a plurality of fields to the task. For each field, a field type 1202 is chosen, and for each field type, additional boxes or fields may further be selected or filled. In addition, the user is provided another box 1204 to add questions or comments with the task. Finally, an “Add Field” button 1206 is provided to add any number of fields to the task as necessary.

FIG. 13 shows the final step of the task creation process. There, a preview 1302 of the task is presented for the user to review, and one or more tags 1304 may be attached to the task.

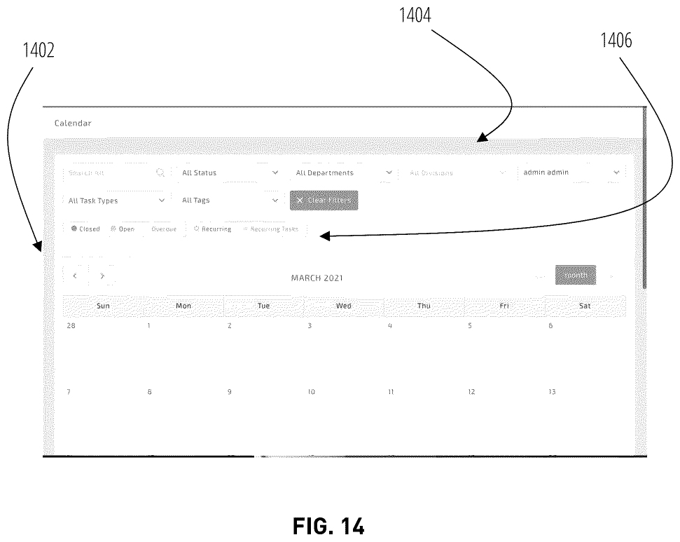

FIG. 14 shows an example of the view accessed via the calendar 606 tab button. There the user can view different calendar views 1402 (here shown as a monthly view, but can also be changed to a weekly view or list view). On the calendar view 1402, different tasks may be shown based on, for example, their due dates. Filters 1404, as discussed above, may be applied to focus on a relevant selection of tasks only. Each task on the calendar view 1402 may have a status indicator. The legend 1406 indicates which color is applied to a task based on its status. These may include, for example, different colors for being closed, open, overdue, or if the task is a recurring task. Future recurring tasks may be shown in light gray or similar to indicate that these tasks are due to populate the calendar view 1402 in the future.

In the calendar task view 1402, tasks can be dragged and dropped into new days to instantaneously change their due dates. Clicking on a task brings the task screen.

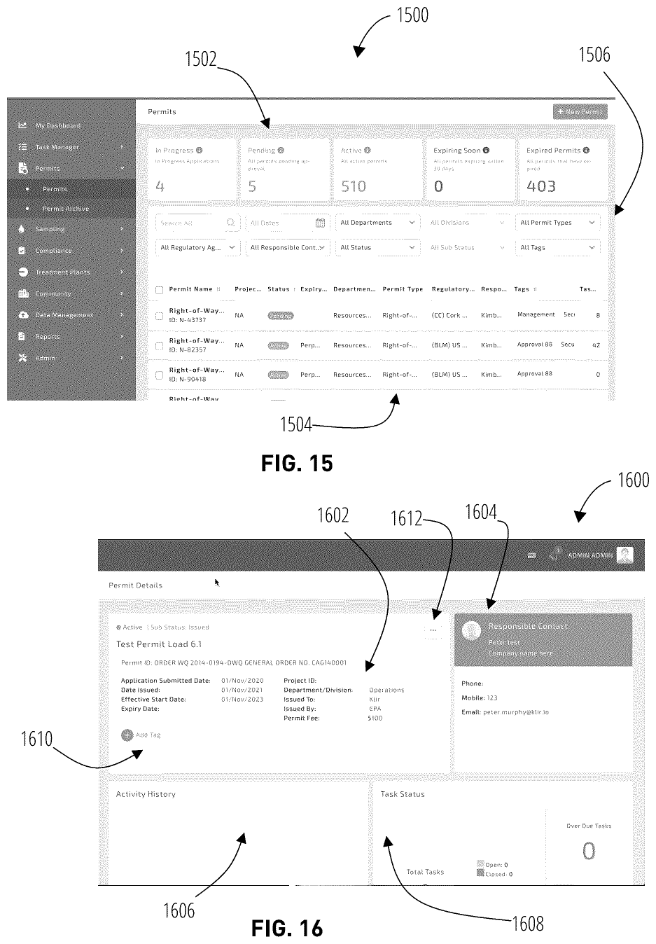

FIG. 15 shows an example of the permit manager view 1500 in accordance with one embodiment. The view shows a list of all permits across all permit types. This may include regulatory permits issued to the water-related entity and required for a multiplicity of legal purposes. On the top, a summary 1502 showing all of the permits currently in the system, including the number of permits that are in progress (being applied for), pending approval or currently active.

On the bottom is shown a listing of permits 1504, which can be sorted by related project ID, status (in progress, pending or active), expiry date, permit type, regulatory agency, tags or the number of associated tasks. A plurality of filters 1506 may be used to restrict the listing by date, departments, divisions, permit types, regulatory agencies, status, or tags.

Upon the user clicking or selecting a permit in the listing of permits 1504, a permit details view 1600 is presented, an example of which is shown in FIG. 16. The permit details view 1600 allows the user to quickly see any relevant information pertinent to the selected permit. For example, permit details 1602 in FIG. 16 include the permit status (e.g., active or other), the permit ID, the application submitted date, the date issued, the effective start date, the expiry date, the project ID associated with the permit, the department/division the permit applies to, the water-related entity the permit was issued to, the entity which issued the permit, and the permit fee.

In addition, a contact information panel 1604 is also shown to the user, comprising contact information (e.g., email, phone number, etc.) of the individual responsible for the designated permit. At the bottom, an activity history 1606 showing a listing of activities or events related to the designated permit (e.g., tasks being opened, reopened, deleted, etc.) and a task status panel 1608 showing via a list or plot/diagram the task status of a plurality of tasks associated with the designated permit. In some embodiments, a “Add Tag” button 1610 is also provided to the user to add additional tags to the designated permit.

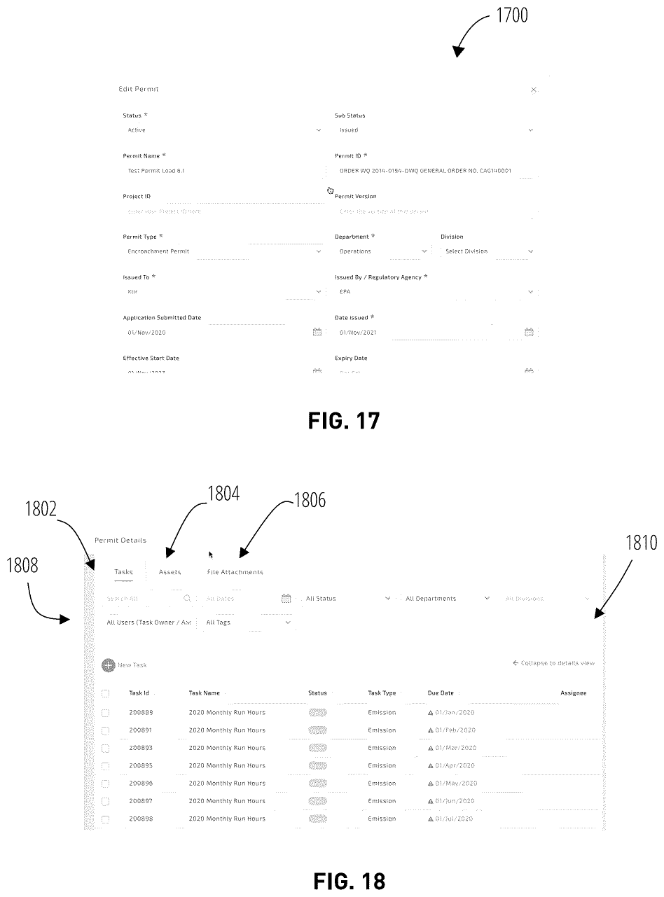

An edit button 1612 is provided, so as to let the user change or edit details relating to the designated permit, or to archive the permit. An example of the permit editor 1700 is presented in FIG. 17.

Scrolling down on the permit details view 1600, as shown in FIG. 18, the user may access 3 tabs: the tasks tab 1802, the Assets tab 1804, and the File Attachments tab 1806. FIG. 18 further shows the task tab 1802 being selected, which presents a list of tasks 1808 related to the selected permit. This list may be searched or filtered using the search box and filter fields 1810. The Assets tab 1804 similarly allows to view a list of asset emissions that fall under the selected permit. For example, this may include the amount of emission (e.g., small air particulate contaminants or others) calculated or derived from a number of hours an asset (e.g., a generator or other) has been running.

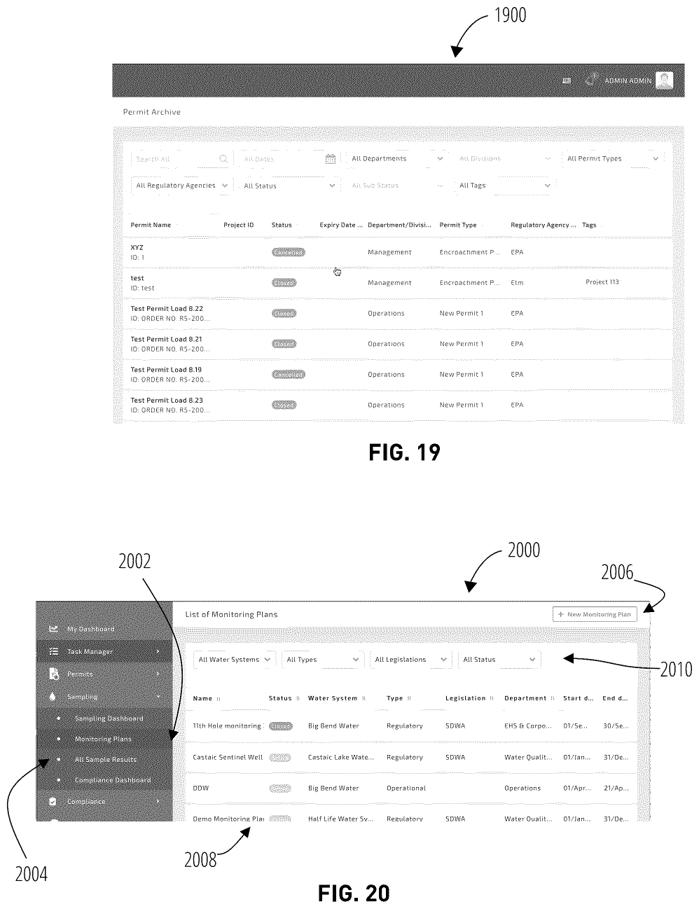

FIG. 19 shows a permit archive view 1900, in accordance with one example. This view shows a listing of closed permits, which can be tailored using a plurality of filters.

In some embodiments, the sampling tab 310 gives further access to a plurality of sub-tabs, for example: a monitoring plans 2002 and all sample results 2004. FIG. 20 shows an example of the monitoring plan view 2000 accessed via the monitoring plan sub-tab 2002. In some embodiments, a monitoring plan can be created (via the New monitoring plan button 2006) by any user to manage a plurality of water sampling plans directed to a same water system (which can comprise multiple facilities). Any number of monitoring plans may be created by the user. In this example, a list of monitoring plans 2008 is shown to the user, which may be tailored using a plurality of filters 2010. In this example, the list 2008 shows each monitoring plan with a plurality of relevant information, including the status of the monitoring plan (e.g., opened, closed, etc.), the name of water system the monitoring plan is directed to, the type of monitoring plan (e.g., regulatory or operational), the relevant legislation, the department responsible for the monitoring, and the start/end dates of the monitoring plan.

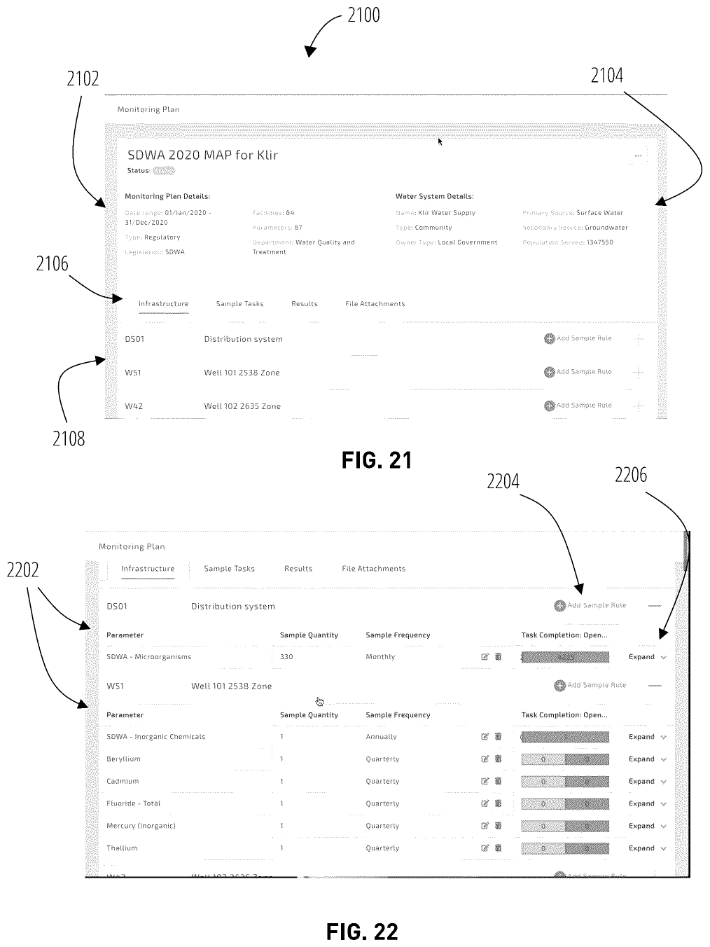

Upon the user selecting or clicking on a plan, a details view 2100 of the selected monitoring plan is shown, as shown in FIG. 21. In this example, on one side, a plurality of details 2102 regarding the monitoring plan are shown to the user, including the status of the monitoring plan, the date range (start date to end date of when the plan is applicable), the type of monitoring plan, the applicable legislation, the number of facilities covered by the monitoring plan, the number of parameters being monitored and the relevant department. On the opposite side details 2104 about the water system the monitoring plan applies to are also shown. These include, for example, the name of the water system, the type of water system, the owner type, the primary and secondary water sources (e.g., surface water or groundwater) and the population served by the water system.

A list of tabs 2106 is further presented to the user, including in this example an infrastructure tab, a sample task tab, a results tab, and a file attachment tab. FIG. 21 shows the infrastructure tab being selected, so as to show a list 2108 of infrastructures currently being included in the monitoring plan (e.g., wells, etc.).

In some embodiments, as shown in FIG. 22, upon selecting an infrastructure from the list 2108, a list of sampling rules 2202 associated with this infrastructure are presented. These may include the parameter(s) (e.g., compounds) being monitored at the site/infrastructure (“SDWA—Microorganisms”, “SDWA Inorganic Chemicals”, or elements such as Beryllium, Cadmium, Fluoride, Mercury, thallium or others), the number of samples, the sampling frequency (e.g., weekly, monthly, quarterly, annually, etc.) and completion bar illustrated the degree of task completion for this monitoring plan.

In some embodiments, test data entered or received into the system may trigger a rules engine, which will be discussed further below. For example, upon a compound/parameter being entered into the system, a rule may be triggered that automatically adds additional compounds/parameters to be monitored. In addition, for each infrastructure, a create/add sample rules button 2204 is provided.

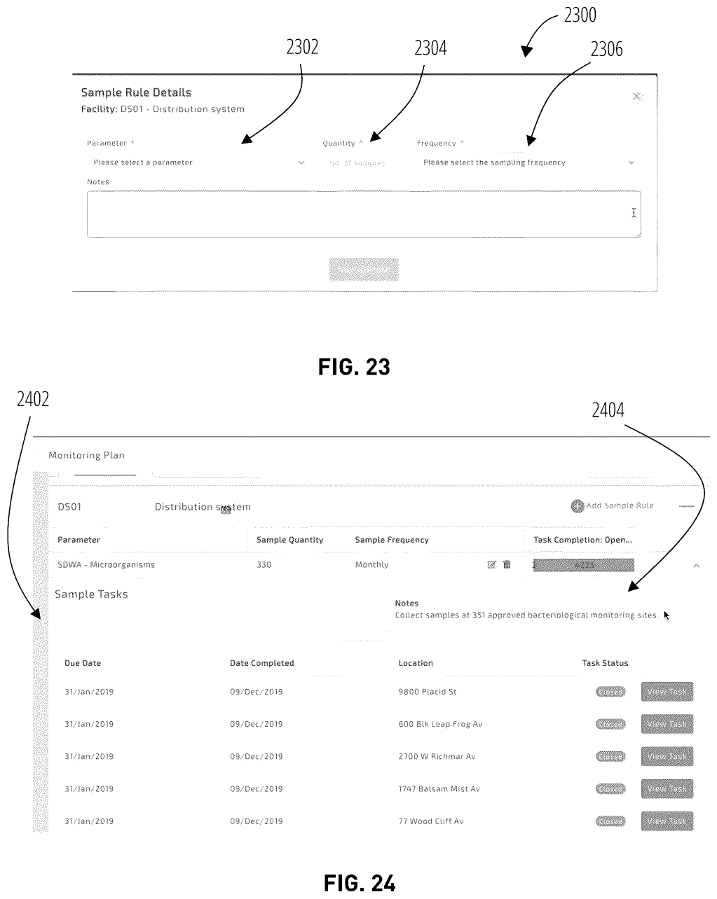

FIG. 23 shows an example of the sample rule creator view 2300. This includes different fields that need to be selected or chosen by the user. For example, the parameter selection menu 2302 allows the user to choose from a list of compounds that are to be monitored. This list may include any known organic or inorganic compound, without limitation. In addition, the user may select a number of samples (Quantity 2304) to be taken for that parameter and a sampling frequency 2306.

FIG. 24 shows an example of the list of sample tasks 2402 that is presented to the user upon the user selecting the expand button 2206 shown in FIG. 22 for a given monitoring plan. The list shows all sampling tasks associated with the monitoring plan, including the due date, date completed, location and task status of each task. A text box 2404 is provided to the user to write comments or notes. This allows the user to view what samples were taken at a given location and at a given time.

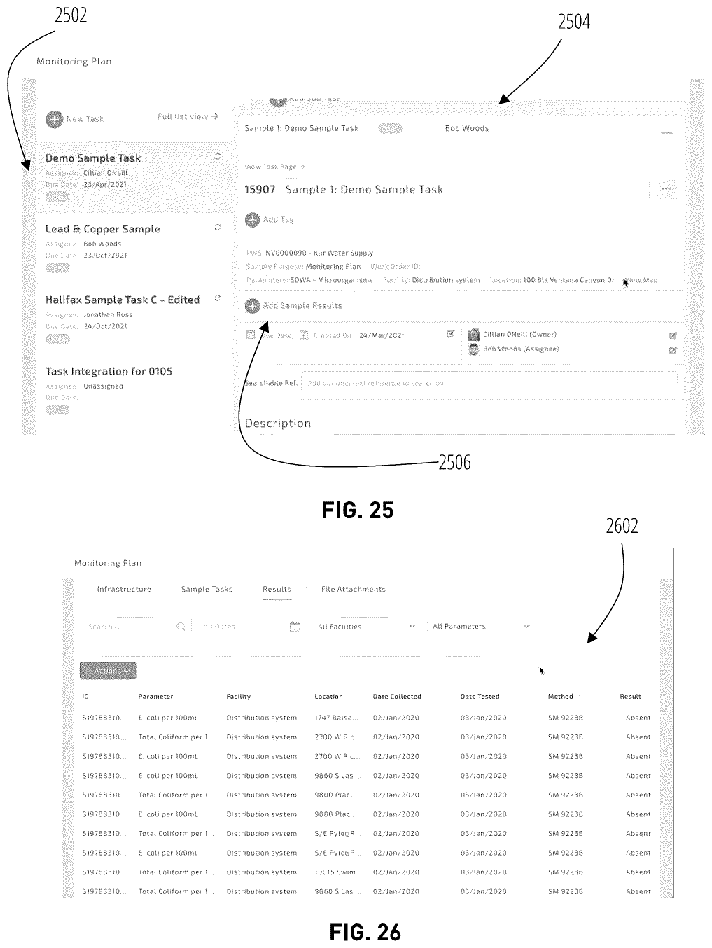

Going back to FIG. 20, upon the user selecting the all sample results sub-tab 2004, a sample tasks view for this monitoring plan opens up. An example is shown in FIG. 25, where on the left a list 2502 of sampling tasks, and on the right side 2504 the detail of the selected sample task is shown. Each sample task has an owner, and one or more assignees which are responsible to take the samples. A button 2506 is shown allowing the assignee to enter the sample results.

In some embodiments, sampling data (or other data) may be received via a SFTP file transfer (or other methods). Upon the data being received, a check is made against the received data with respect to the configuration of each of the sampling task currently in memory. If the configuration matches an existing opened task, the system will automatically close the task.

FIG. 26 shows an example of the sample result view 2602 shown to the user upon selecting the “Results” tab from the tab selection 2106. There the user can view the list of sampling results entered in the system for the monitoring plan. Additional information presented include the sample ID, the parameter (e.g., compound sampled and concentration thereof), the facility, the location, the date the sample was collected at the location, the date the sample was analyzed or tested, the testing method and the results (e.g., absent/present, etc.). A search box and selection of filters are also provided.

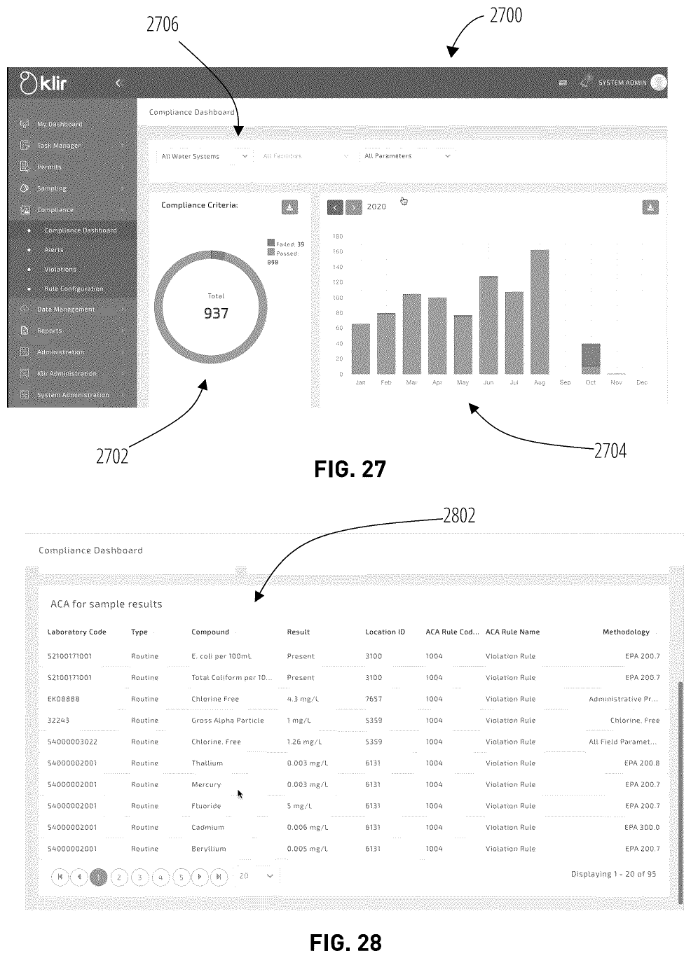

FIG. 27 shows an example of the Compliance dashboard view 2700. This allows the user to rapidly view if any compliance requirements have failed, and to see the overall performance of the water-related systems. For example, a graphical plot 2702 is shown illustrating the percentage of passed and failed sample evaluations on the left, while on the right a time-based histogram 2704 is shown, illustrating the amount of passed and failed evaluations for each month. A selection 2706 of drop-down menus are provided to the user so as to select which system, facilities, and parameters the shown violations apply to.

Scrolling downwards on the compliance dashboard 2700, a table 2802 showing a list of times when the rules engine has been triggered. This list also includes, in this example, for each time a rule was triggered, the laboratory code, type, compound, result, location ID, rule number, rule name and associated methodology.

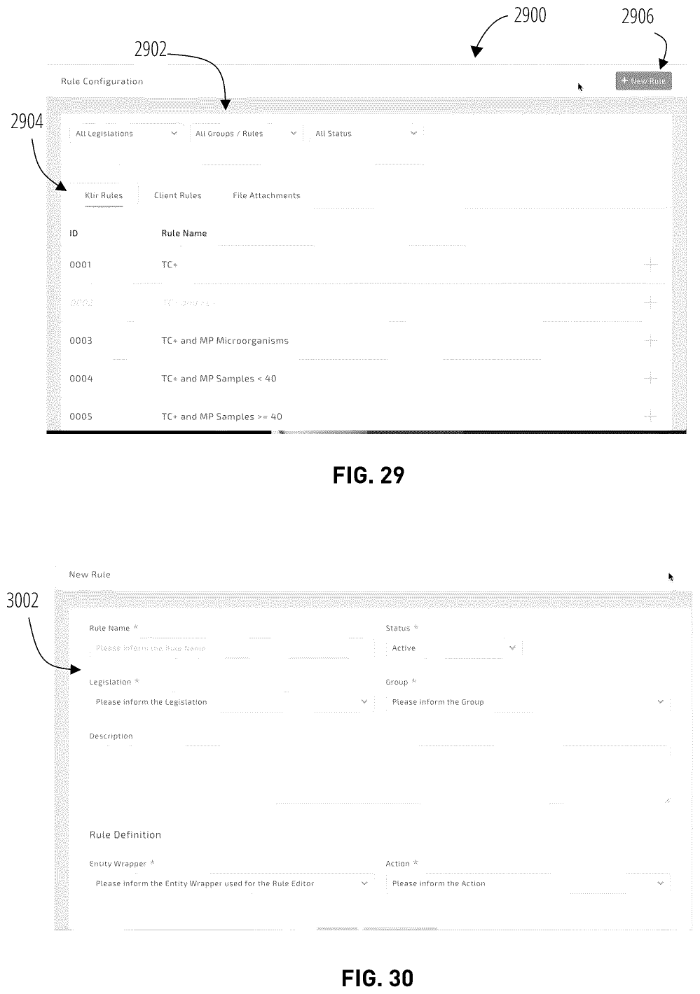

FIG. 29 shows an example of the Rule Configuration view 2900. There the user can view lists of pre-defined rules. A selection of filters 2902 is presented to the user, and tabs 2904 allow the user to display either. New rules may be created or added by the user via the “+New Rules” button 2906.

FIGS. 28 and 29 show an example of the rule creator accessed via the button 2906. This provides a number of fields 3002 allowing the user to choose the name of the rule, its status (active or inactive), the legislation the rule will be associated with, and the associated group. A description box is also provided.

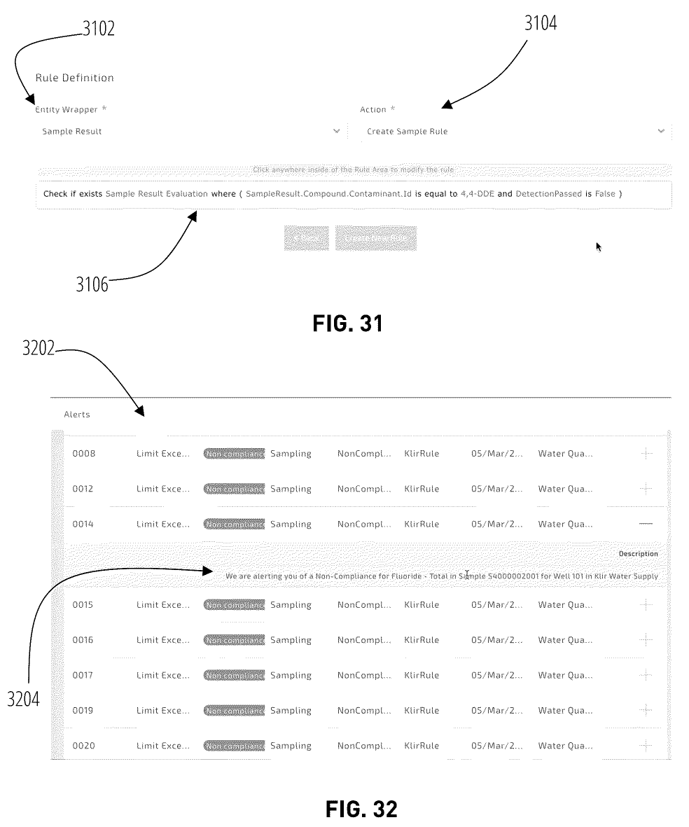

FIG. 31 shows the rule definition view, where the actual rule is defined. An entity wrapper field 3102 is provided, so that the user may select a wrapper associated with the rule. This wrapper includes a data element the rule will be focused on. This may include for example a sample result, a permit, a water system, etc. In addition there is provided an action field 3104, where the user selects the type of action that is automatically triggered or executed upon the rule meeting the pre-defined conditions. This may include a sample rule, or a trigger/alert.

The rule is defined in a rule editor 3106, where the user may define the rule conditions by writing a Boolean expression using a scripting language. The expression may refer to any data element stored in the system discussed above, and a plurality of nested statements may be used as well. The editor may be configured to provide some functionality of an integrated development environment (IDE), for example code completion functionalities or the like.

FIG. 32 shows an example of compliance alerts view 3202, where a list of alerts triggered by the rules being actively processed by the system. Upon selecting an alert, a short description 3204 of the alert is shown to the user, describing why the alert why triggered (e.g., a non-compliance, etc.).

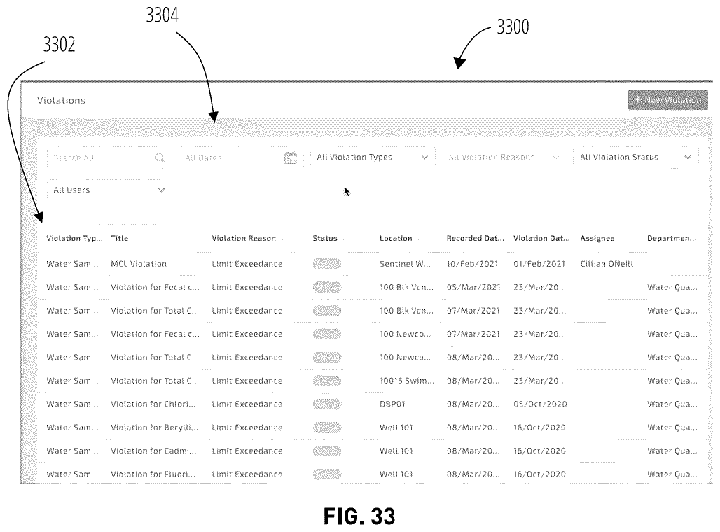

FIG. 33 shows an example of the compliance—violations view 3300. In this example, a list 3302 of compliance violations is shown to the user, which can be searched or filtered using the search and filter options 3304. Each violation in the list comprises information such as, for example, the violation type, title, violation reason (e.g., for example limit exceedance, etc.), its status (e.g., active or not), the relevant location, the date the recorded date, the violation date, the assignee and the department.

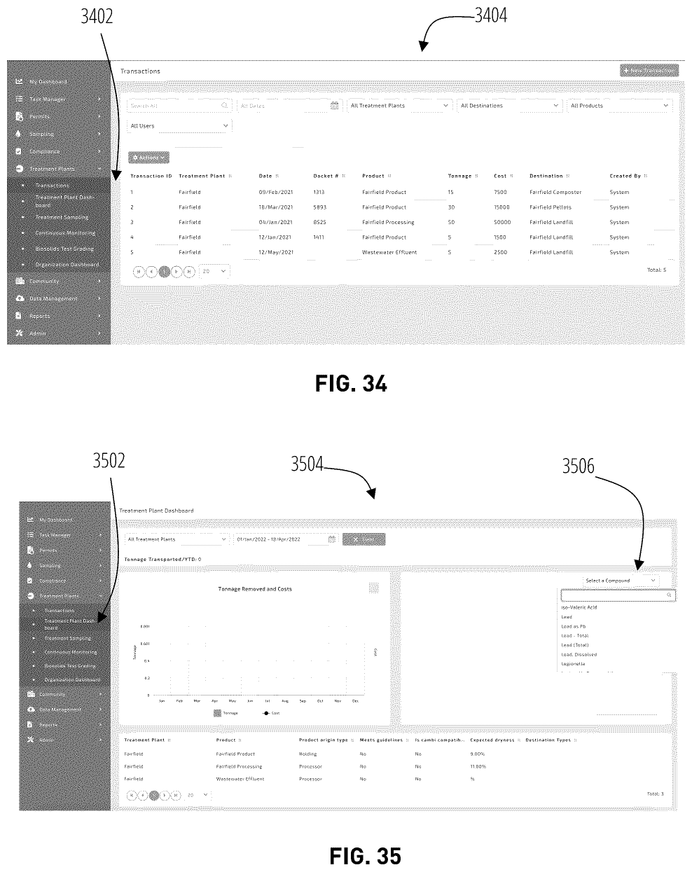

In some embodiments, as shown in FIG. 34, the treatment plants tab 320 comprises a Transaction sub-tab 3402, which may be used to access a transaction view 3404 showing a searchable list of transactions related to different treatment plants. The list may comprise information such as, for example, the transaction ID, the date of transaction, the docket number, the name of the associated product, the tonnage, the cost, and the destination.

In some embodiments, the treatment plant tab 320 may comprise a treatment plant dashboard sub-tab 3502. FIG. 35 shows an exemplary treatment plant dashboard view 3504 accessed via the sub-tab 3502. Therein is shown different windows illustrating different types of information relating to the treatment plants. For example, this may include a plot or graphical representation showing the tonnage removed and costs of a given treatment plant, a list of different treatment plants, and a selection 3506 for selecting specific compounds or substances being monitored or treated by the treatment plant, which may be viewed via a plot or graphical representation.

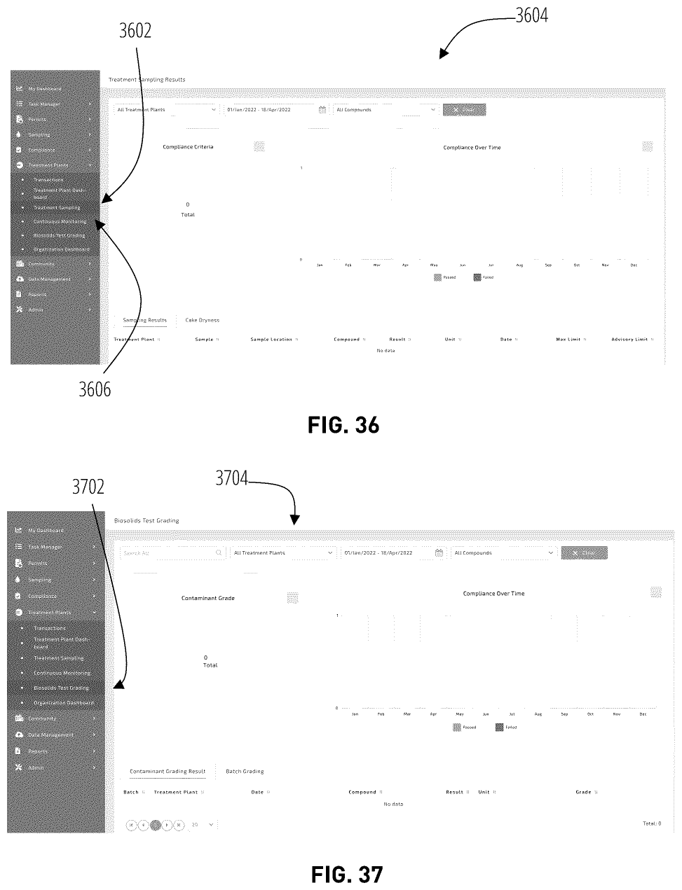

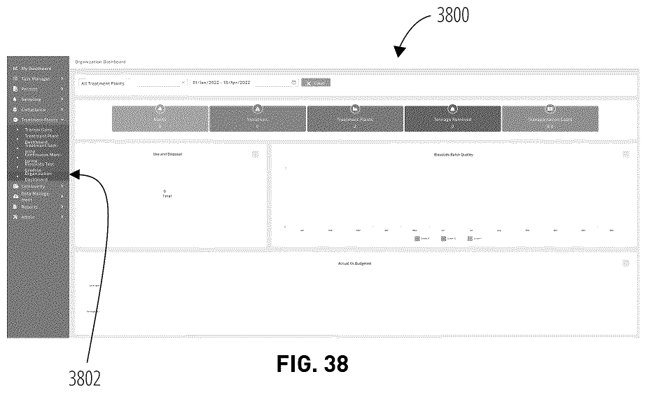

In some embodiments, as shown in FIG. 36, the treatment plant tab 320 may comprise a treatment sampling sub-tab 3602 for accessing a treatment sampling view 3604. This may be used for viewing a list, plot or other graphical representations of the different treatment plants shown as a function of compliance criteria or compliance over time. For example, a searchable list of sampling results or cake dryness may be accessed therefrom. The treatment plants may be viewed according to dates, clients, or compounds. In addition, in some embodiments, a continuous monitoring sub-tab 3606 may also be provided, which provides a similar view, but which can be targeted to a specific asset instead of specific compounds. Thus, the current monitoring status of that specific asset and information pertaining thereto can be viewed.

In some embodiments, the treatment plants tab 320 may further comprise a biosolids test grading sub-tab 3702 to access a biosolids test grading view 3704. In one example, as shown in FIG. 37, this view may be used to access information about the contaminant grading results or batch grading of tests done at different treatment plants for different compounds. This may include showing a contaminant grade indicator and a compliance over time plot for the selected compounds.

In some embodiments, the treatment plants tab 320 may further comprise an organization dashboard sub-tab 3802 to access an organization dashboard view 3800. There is shown a plurality of data regarding different aspects of the treatment plants. These may include a summary showing the number of alerts, violations, treatments plants, tonnage removed and transportation costs. This view may further include time-based plots of the biosolids batch quality, and comparison of the actual costs vs the budgeted costs associated with treatment plants.

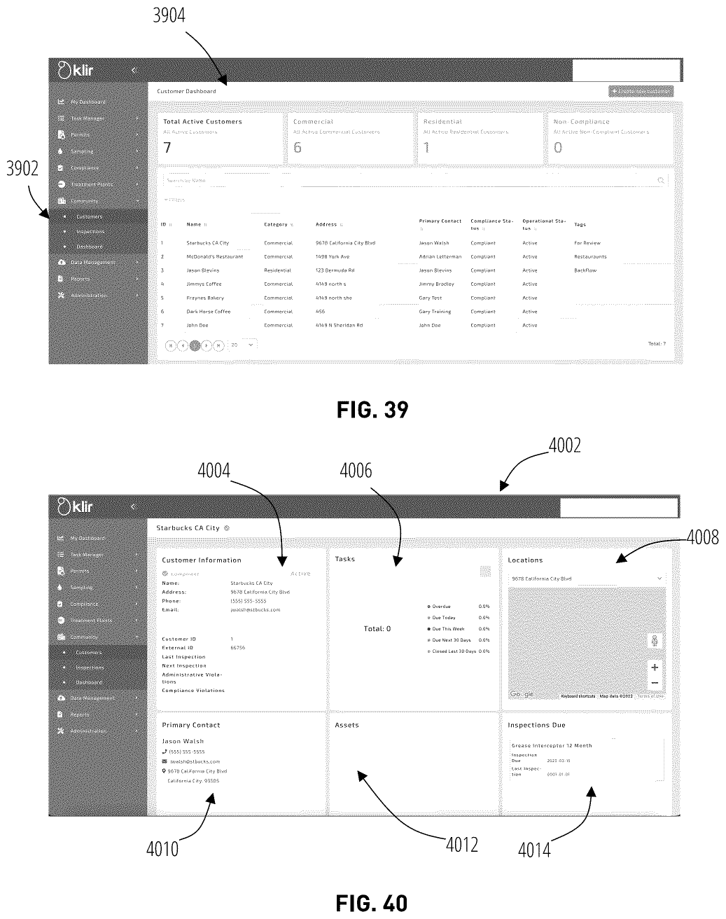

In some embodiments, the community tab 512 further includes a customer sub-tab 3902. In the example of FIG. 39, this presents a customer dashboard view 3904 which includes a searchable list of customers. In this example, at the top a plurality of boxes are present showing a number of customers in different categories: a total number of active customers, the number of commercial customers, residential customers and the number of customers that are currently in non-compliance.

In some embodiments, the user can select a customer from the list of customers to open a client view to obtain more information about that client. FIG. 40 shows an exemplary client view 4002, which contains additional information pertaining to this customer. This may include, for example, customer information 4004 (e.g., a name, address and phone and/or email), a list of tasks associated with that client 4006, a map 4008 showing one or more locations associated with the client, a primary contact information 4010, a list of assets 4012 and a list of inspections due 4014.

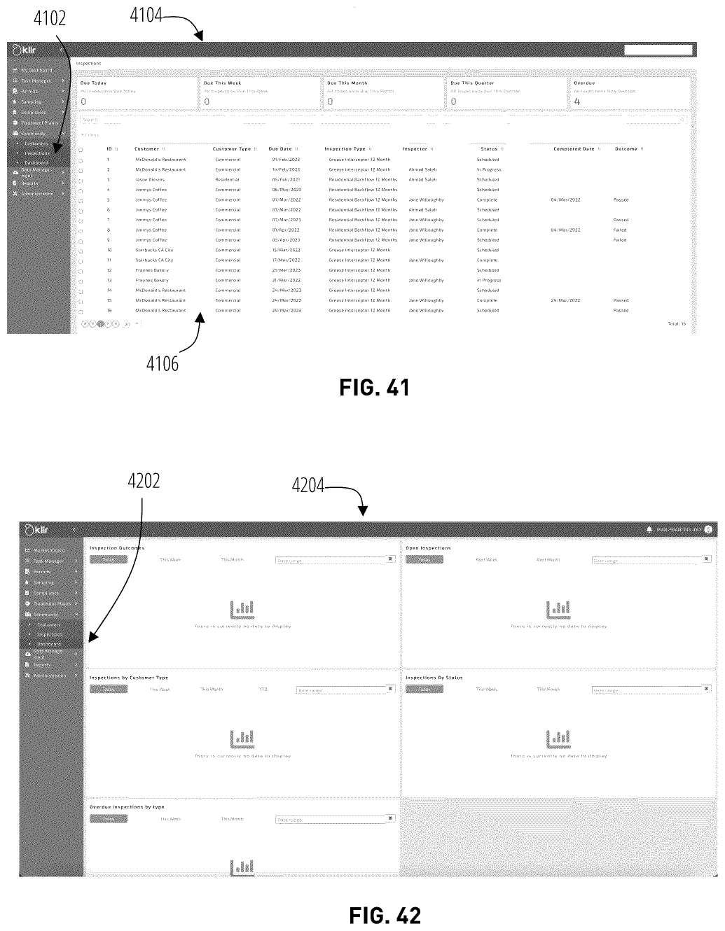

In some embodiments, the community tab 512 comprises an “Inspection” sub-tab 4102. As shown in FIG. 41, this may provide the user with an inspection view 4104 which includes a searchable list of inspections 4106. In the example of FIG. 41, this list may include the customer or client name, a customer or client ID, an inspection due date, an inspection type, the name of an inspector (if any), and a status (e.g., in progress, scheduled, complete, etc.). Above, boxes are used to clearly show the total number on inspections that are due today, in the current week, current month or in the current quarter. In some embodiments, further clicking or selecting an inspection in the list 4106 provides further information about that inspection.

In some embodiments, the community tab 512 further includes a dashboard sub-tab 4202, which provides a view 4204 showing information about the different inspections in the system. Instead of a single list, different windows are provided showing lists, plots or graphical representations of the inspections with respect to different categories. These may include, for example, different inspection outcomes, inspection by customer types, overdue inspections by type, open inspections or inspections by status. For each, the different representations may be presented by day, week or month.

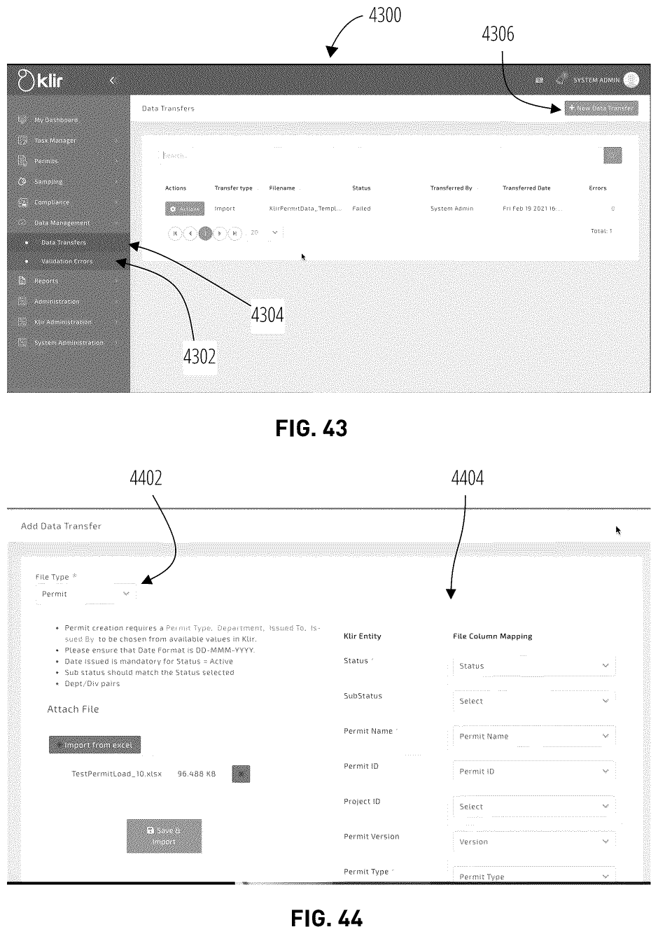

In some embodiments, as illustrated in FIG. 43, the data management tab 514 may comprise two sub-tabs: data transfers 4302 and validation errors 4302. FIG. 43 further shows an example of the Data Transfers view 4300 accessed via the data transfer sub-tab 4304, which allows the user to transfer or import new data files into the platform. It includes a New Data Transfer Button 4306 which opens a file transfer window. Different file types may be imported, including files related to: permits, permit tasks, sample tasks, locations, water samples, facilities, compounds, compound legislation, professionals (e.g., community), inspections, inspection types, customer addresses, community customer contacts, community assets, and customer details.

FIG. 44 shows an example of the file transfer window, wherein the user may select a file type 4402 to be imported (in this example a permit file type is selected). In addition, the system may be configured to automatically parse the data file to be imported to identify column headers or the like, and to automatically assign each column to a pre-defined data entity or object. In other cases, the user may manually select which column is assigned to which data entity, for example as shown at 4404.

In the case of permits, a plurality of different permit types may be automatically recognized. These may include, without limitation: aboveground fuel storage tank permits, air permits, asbestos national emissions standards for hazardous air pollutants notification of asbestos abatement, asbestos waste management, authority to construct permit major stationary source, authorization to transport asbestos permits, blasting permits, building permits, Bureau of Land Management grazing permits, Bureau of Reclamation Land Contracts, Chemical Accident Prevention Program registrations, Wastewater permits, Landfill permits, Clearing and Grubbin Permits, compressed Gases Permits, Concrete Pavement Permits, Conditional Grading Permits, Contractors Right of Entry Agreements, Control Plan Blanket NDOT, Cryogenic Fluids Permits, Cryogenic Storage Permits, De Minimis (Cat. 1-Cat. 4) Permits, Declarations of Non-Hazardous Waste, De Minimis Water Discharge Permits, Discharge Notification Letters, Domestic Wastewater Holding Tank Permits, Dust Control Blanket Permits, Dust Control Permits for Construction Activities, Dust Control Permits, Easement Occupancy Permits, Electrical Permits, Emergency Engine Inventory, Emergency Permits, Encroachment Permits, Endangered species recovery Permits, EPA ID Number, Excavation Permit, Fence/Wall Permit, Flammable/Combustible Liquids Above Ground Storage Tanks Permits, Flammable/Combustible Liquids Permits, General Discharge Permit for Oil/Water Separators, General Pesticide Permits, Grading and Drainage Permits, Grading Permits, Groundwater Discharge Permits, Hazardous Materials Permits, Hazardous Materials Storage Permits, Hazardous Waste EPA ID Number, Holding Tank Permits, Hot Work Permit, Impound Dam Permit, Industrial Permitted Facility, Industrial Wastewater Discharge Authorizations, Kinder Morgan Energy Partners Pipeline Occupancy Permits, Land Disposal Restriction Forms, Landscape Certificates of Compliance, Letters of Approval to Construct, Minor Source, Motor Fuel Dispensing Permits, Nationwide Permit Authorization, Ndot Permits, NESHAP Notifications, NPDES, Occupancy Permits, Off-Site Construction Permits, Oil Water Separator Permits, Onsite Sewage Disposal System Permits, Petroleum Fund, Petroleum Fund Registrations, Portable Source Permit Move Notice, Radioactive Materials Permit, Recharge, Regulated Construction Project Notification Forms, Research and Collection Permits, Restricted Waste Permits, or others.

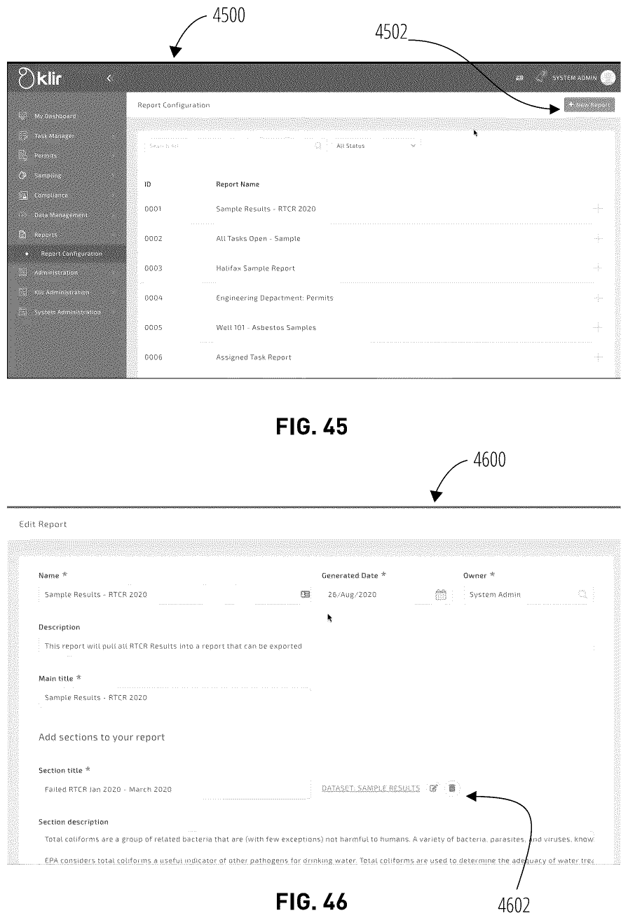

FIG. 45 shows an example of the Reports view 4500 access via the reports tab 516. There, the user may view and generate reports. A New Report Button 4502 is provided which launches an edit report view configured to help the user draft a report using the data already in the system. A list of currently available reports is also shown to the user, which can be searched via a search bar.

FIG. 46 shows an example of the edit reports view 4600, which is in the form of an editor configured to allow the user to efficiently draft a report using a plurality of pre-defined fields. In addition, multiple sections 4602 may be added to the report, and dataset files may also be attached with the corresponding section.

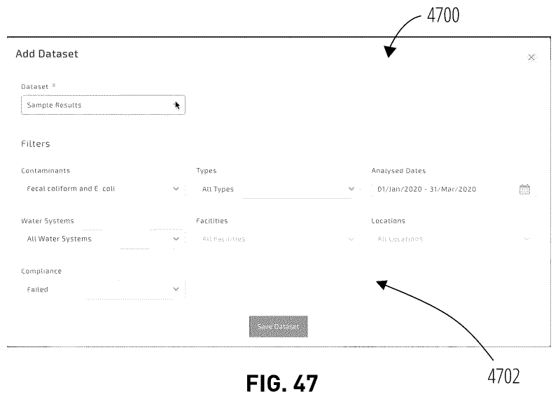

An example of the Add Dataset view 4700 is shown in FIG. 47. There, the user may select a dataset from a list, which can be filtered using one or more filters 4702. These filters may include, for example, contaminants, types, analyzed dates, water systems, facilities, locations, and compliance. Each report may be assigned to one or more owners, which may be a department or division, or another user. Upon the report being generated, it is emailed to report owner(s).

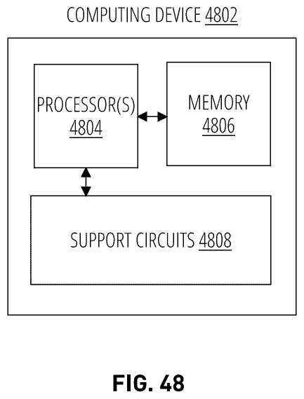

FIG. 48 illustrates schematically an exemplary computing device 4802 which may be used to implement the above described systems and methods, for example server 102 and/or user device 104 of FIG. 1, in accordance with one embodiment. In this exemplary embodiment, computing device 4802 is a computing device that comprises one or more digital processors 4804 communicatively coupled to a memory 4806 and support circuits 4808. Processors 4804 may be any commercially available processors, microprocessors, microcontrollers, and the like. The support circuits 4808 may comprise well-known circuits that provide functionality to the processor 4804, such as, a user interface, clock circuits, network communications (for example via a network interface or adapter), cache, power supplies, I/O circuits, and the like. The memory 112 may be any form of digital storage used for storing data and executable software. Such memory includes, but is not limited to, random access memory, read only memory, disk storage, optical storage, and the like.

Any module, unit, component, server, computer, terminal, engine, or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto. Further, unless the context clearly indicates otherwise, any processor set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

Furthermore, any module, unit, component, server, computer, terminal, engine, or device exemplified herein can have one or more input/output (I/O) interface to allow communication with a human user and/or with another computer via an associated input, output, or input/output device such as a keyboard, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A computer-implemented method for automatically evaluating compliance requirements of a water-related entity, the water-related entity providing one or more water-related services, the method comprising:
receiving, on a server, from a plurality of network-connected devices communicatively coupled to the server via a network, a plurality of data elements, each data element being associated with one of said plurality of water-related services;
receiving, on the server, from said plurality of network-connected devices, a plurality of Boolean inputs, each input describing a logic-based rule that is to be automatically evaluated against at least a subset of the plurality of data elements;
for each input of the plurality of Boolean inputs:
processing, on the server, each logic-based rule on said subset to identify a triggering event; and
displaying, on at least some of said plurality of network-connected devices, said triggering event.

2. The computer-implemented method of claim 1, further comprising the steps of:
creating, from the plurality of network-connected devices, a plurality of water-related tasks, each of said plurality of water-related tasks being associated with one of said plurality of water-related services;
storing said plurality of water-related tasks on a database communicatively coupled to said server;
displaying to the user, on at least one device of said plurality of network-connected devices, a list of the plurality of water-related tasks.

3. The computer-implemented method of claim 2, wherein at least some of said plurality of tasks are created via a task generator using a task template.

4. The computer-implemented method of claim 3, wherein each of said task further has attached thereto one of: comments, forms, questions, and attached files.

5. The computer-implemented method of claim 4, wherein each of said task has a tag attached to it, the tag being associated with another user, and wherein upon said task being created, automatically sending an electronic message to said another user.

6. The computer-implemented method of claim 3, wherein said using a task template comprises the steps of:
selecting a task type template from a list of task templates;
associating the task with one or more of said plurality of data elements;
inputting an end date, due date and recurrence; and
adding one of: a form, a question, or a tag.

7. The computer-implemented method of claim 6, wherein said task type templates includes: a general task, a sample tasks linked to a monitoring plan, a permit task linked to a specific permit, an emission task linked to a specific permit.

8. The computer-implemented method of claim 1, wherein at least one of said plurality of data elements is a permit data element that comprises permit information and wherein said task is associated with said permit data element is directed to a compliance requirement of said permit.

9. The computer-implemented method of claim 1, wherein at least one of said plurality of data elements is associated with an asset of said water-related entity.

10. The computer-implemented method of claim 9, wherein said asset is a generator and at least one of said data elements is an asset data element comprising a number of hours the generator has been running.

11. The computer-implemented method of claim 10, wherein an amount of contaminant is automatically derived from said number of hours the generator has been running.

12. A system for automatically evaluating compliance requirements of a water-related entity, the water-related entity providing one or more water-related services, the system comprising:
one or more servers;
one or more databases communicatively coupled to said one or more servers and used to store thereon a plurality of data elements, each data element being associated with one of said plurality of water-related services;
a plurality of network-connected devices communicatively coupled to said one or more servers via a network; and
wherein the one or more servers are configured to:
receive, from the plurality of network-connected devices, a plurality of data elements, each data element being associated with one of said plurality of water-related services;
receive, from said plurality of network-connected devices, a plurality of Boolean inputs, each input describing a logic-based rule that is to be automatically evaluated against at least a subset of the plurality of data; and
for each Boolean input:
processing said logic-based rule on said subset to identify a triggering event; and
displaying, on at least some of the plurality of network-connected devices, said triggering event.

13. The system of claim 12, wherein the system is further configured to:
create, on the plurality of network-connected devices, a plurality of water-related tasks, each of said plurality of water-related tasks being associated with one of said plurality of water-related services;
store said plurality of water-related tasks on said one or more databases;
displaying on the user device, a list of the plurality of water-related tasks.

14. The system of claim 13, wherein at least some of said plurality of tasks are created via a task generator using a task template.

15. The system of claim 13, wherein each of said task further has attached thereto one of: comments, forms, questions, and attached files.

16. The system of claim 13, wherein each of said task has a tag attached to it, the tag being associated with another user, and wherein upon said task being created, sending an electronic message to said another user.

17. The system of claim 12, wherein said using a task template comprises the steps of:
selecting a task type template from a list of task templates;
associating the task with one or more of said plurality of data elements;
inputting an end date, due date and recurrence; and
adding one of: a form, a question, or a tag.

18. The system of claim 12, wherein at least one of said plurality of data elements is associated with an asset of said water-related entity.

19. The system of claim 18, wherein said asset is a generator and the at least one of said plurality of data elements associated with said asset includes a number of hours the generator has been running.

20. The system of claim 19, wherein an amount of contaminant is automatically derived from said number of hours the generator has been running.
